(19) United States
(12) Patent Application Publication
(10) Pub. No.: US 2006/0067787 A1
(43) Pub. Date: Mar. 30, 2006

(54) Pivot lubrication bolt

(76) Inventors: Linn E. Nelson, Portland, OR (US); Karl H. Zeller, Portland, OR (US)

Correspondence Address: DELLETT & WALTERS, P. O. BOX 82788, PORTLAND, OR, 97282-0788, US

(21) Appl. No.: 10/954,795

(22) Filed: Sep. 29, 2004

(51) Int. Cl. F16C 17/04

(52) U.S. Cl. 403/408.1

(57) ABSTRACT

A shearing tool has two blades which are pivoted together by a pivot in conjunction with a nut. The pivot has a head, and a shank which is provided with a lubricant cell and plural channels. The lubricant cell is in communication with the exterior of the shank area, the channels enabling the lubricant contained in the lubricant cell to lubricant the two blades. The lubricant cell includes a depressed oiling region for containing oil therein during re-lubrication. The shank has outer threads to mesh with inner threads of the nut.

### BACKGROUND OF THE INVENTION

This invention relates to bolts for use in connection with joining pivoting members, and more particularly to a pivot bolt with lubricating features

FIG. 1 shows a shearing tool 10 in accordance with the prior art, wherein the tool comprises two blades 12, two handles 14 fastened with the blades 12, and a pivot 14 for pivoting together the blades 12 in conjunction with a nut (on the reverse side of the tool, not shown in the drawing). In order to enable the blades 12 to pivot about the axis 18 in the directions of arrow 20, it is necessary to apply lubricant from time to time to the area at which the two blades 2 are pivoted together. However, such an application of the lubricant can be ineffective at best in reducing friction between the two blades 12. This is due to the fact that the lubricant so applied does not dwell steadily on the pivoting portion of the shearing tool. In other words, the conventional practice of the lubricant application merely results in the waste of lubricant. The lubricant will quickly disperse and spread along the blades away from the pivoting region.

### SUMMARY OF THE INVENTION

In accordance with the invention, a lubricating pivot bolt is provided for use with connection of pivoting members. The pivot bolt is provided with a lubricant cell with plural channels to distribute the lubricant to the mating areas of the pivoting members in the area of the pivot point, to effectively lubricate the pivoting members, thereby resulting in reduction in friction between the members. A lubricant receiving well is provided at the lubricant receiving position, for ease of re-supply of lubricant.

Accordingly, it is an object of the present invention to provide an improved pivoting member joining device.

It is a further object of the present invention to provide an improved pivot point nut member with improved lubricant delivery and re-supply features.

It is yet another object of the present invention to provide an improved oiler bolt for use with pivoting blades, scissor-type moving members and the like.

It is a further object of the present invention to provide an improved lubricant bolt for use in connecting pivoting blades of a shearing tool, trimmers, or the like.

The subject matter of the present invention is particularly pointed out and distinctly claimed in the concluding portion of this specification. However, both the organization and method of operation, together with further advantages and objects thereof, may best be understood by reference to the following description taken in connection with accompanying drawings wherein like reference characters refer to like elements.

### BRIEF DESCRIPTION OF THE DRAWINGS

FIG. 1 is a view of a shearing tool using a connecting bolt in accordance with the prior art;

FIG. 2 is an exploded view of a pivot lubricating bolt in accordance with the present invention;

FIG. 3 is a sectional view taken along line 3-3 of FIG. 2;

FIG. 4 is an exploded view of another embodiment of a pivoting lubricating bolt in accordance with the invention;

FIG. 5 is a sectional view of the embodiment of a pivoting lubricating bolt as shown in FIG. 4, taken along line 5-5;

FIG. 6 is a top sectional view illustrating placement of the lubrication channels; and

FIG. 7 is a top sectional view showing alternative lubrication channel placement.

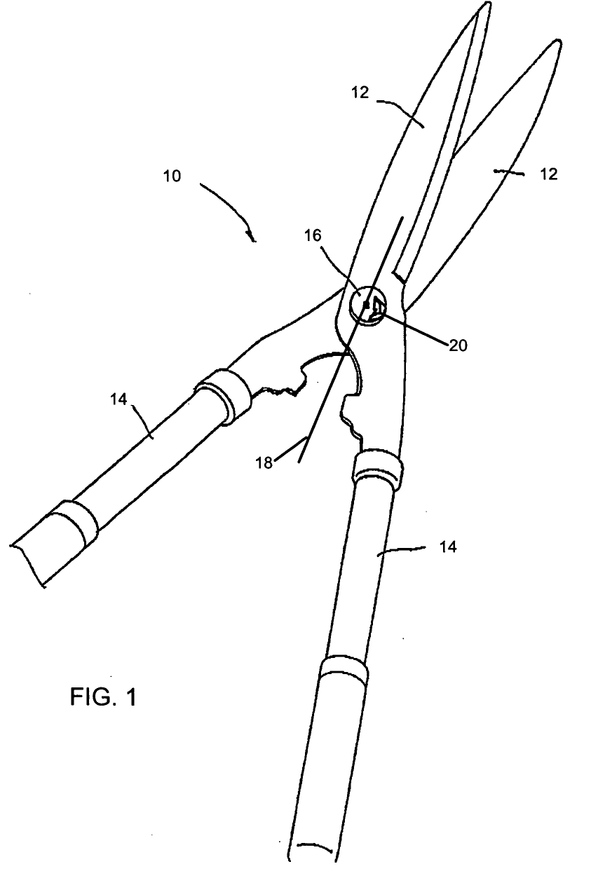

### DETAILED DESCRIPTION

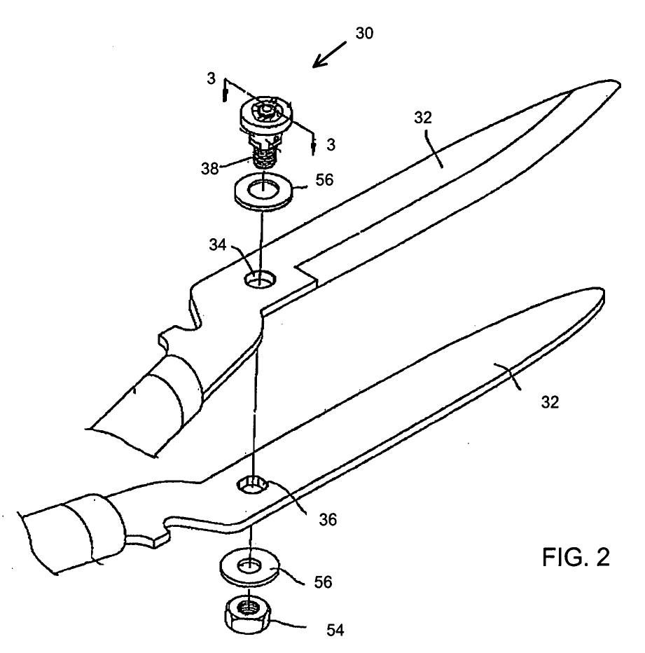

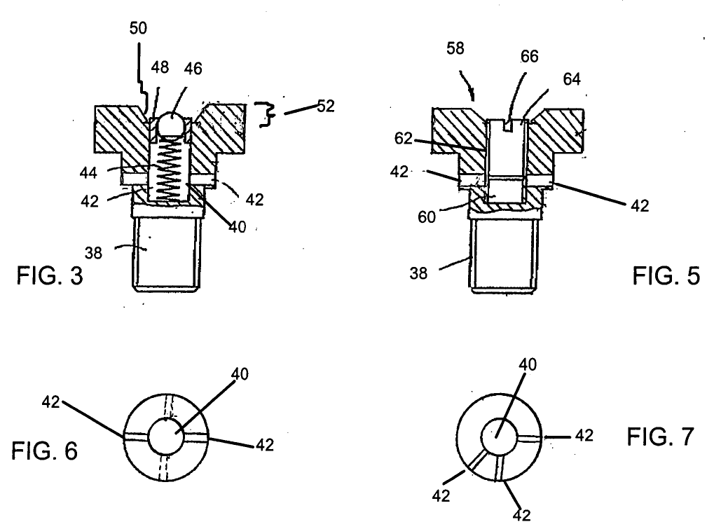

As shown in FIGS. 2 and 3, a pivot lubricating bolt 30, illustrated in connection with use on a shearing tool, such as hedge trimmers, pruning tools or the like, a pivot lubrication bolt 30 is employed to join the two blades 32 of a shearing tool, for example. The blades 32 are provided with pivoting holes 34, 36 for receiving the pivot lubricating bolt 30. The pivoting hole 34 of the first blade is suitably round, whereas the pivoting hole 36 of the second blade is suitably rectangular.

The pivot lubrication bolt 30 is characterized by a head, and a shank. The shank is provided with a male threaded portion 38, a round segment contiguous to the head, a rectangular mid-segment located between the round segment and the male threaded portion, and a lubricant cell 40 with an open end extending through the head. The lubricant cell 40 is provided with two or more channels 42 in communication between the interior of the cell 40 and with the exterior of the shank. The lubricant cell 40 is provided with an elastic or biasing member 44, a covering member 46, and a stop member 48. The elastic member 44 is suitably a coil spring in the preferred embodiment. The covering member 46 is of a spherical construction and is located at the open end of the lubricant cell 40. Covering member may comprise a ball bearing, for example. The elastic member 44 and the covering member 46 are retained in the lubricant cell 40 by the stop member 48 which seals off the open end of the lubricant cell 40.

The covering member 46 and stop member 48 are suitably positioned centrally of the bolt, within a well portion 50 defined in the face of the bolt. The well is suitably formed as a bevel, so as to define a depth 52 between the top of the covering member and the outer face of the bolt 30.

The first blade and second blades 32 are held together in pivoting relation by the pivot lubrication bolt 30 in conjunction with a nut 54 and two washers 56 serving to reduce friction between the blades and the nut.

In use, as the covering member 46 is pressed against the coil spring 44, a gap is created between the covering member 46 and the stop member 48 in view of the covering member 46 being partially moved out of contact with the stop member 48. A lubricant, such as oil, for example, may then be injected into the lubricant cell 40 via the gap. The well portion 50 provides a holding area to receive the lubricant temporarily, until the lubricant may pass by the covering member into the lubricant cell 40. This enables an easier re-supply of the lubricant cell, without the likelihood that the lubricant will spill beyond the extent of the bolt, especially in the case where the lubricant supply nozzle is not precisely inserted into the opening of the stop member.

In use of the tool, the blades 32 are supplied the lubricant via the channels 42 of the lubricant cell 40. The plural channels are suitably arranged radially about the pivot axis so as to provide the lubricant where desired for maximum effect. The preferred embodiment employs 2 such channels, but more may be employed in different applications other than the illustrated shear. For example, in a configuration have 3 or 4 such channels, the channel diameter may be reduced to ensure a slower feed rate of the lubricant. The channels may be regularly spaced about the bolt, or, may be positioned irregularly, if the particular configuration of the pivoting members is such as to desire greater lubricant delivery in one region relative to another.

As shown in FIGS. 4 and 5, a second embodiment of the pivot lubrication bolt comprises a pivot 58 which has a corresponding configuration to that of the bolt 30 described hereinabove, but with a different construction of the lubricant cell. The lubricant cell 60 is receiving in the body of the bolt and is provided with an inner threaded potion 62 which is engaged with a plug member 64, the plug being provided at the outer end with a slotted head 66.

In this embodiment, before the lubricant is injected into the lubricant cell 60, a screw driver is used to turn the plug 64 such that the screw driver is engaged with the slotted head 66 of the plug 64. The plug is removed, and lubricant is added to the lubricant cell. The plug is then re-inserted into the opening. In use, to cause lubrication to be dispensed via the lubrication channels 42, a screwdriver or other suitable device is inserted into the slot 66, and the plug 64 is rotated to cause it to move inwardly toward the bottom of the lubricant cell. This causes the lubricant to be forced out of the lubricant cell via the channels. The amount of lubricant thereby dispensed can be controlled by the amount of rotation of the plug 64. This is particular useful in cases of using a lubricant which has a higher viscosity, and the lubricant suitably remains in the lubricant cell until the rotation of the plug member.

While the illustrated slotted head is of the “−” type for use with the “−” type screwdriver, and “+” type head or hexagonal head or square drive head may also be employed, for example, for actuation by “+” type drivers or square or hex head drivers.

The bolt 58 also employs the well portion 50 so as to provide a region to contain lubricant while refilling, to lessen the likelihood of spilling and to ensure that the lubricant will end up in the lubricant cell.

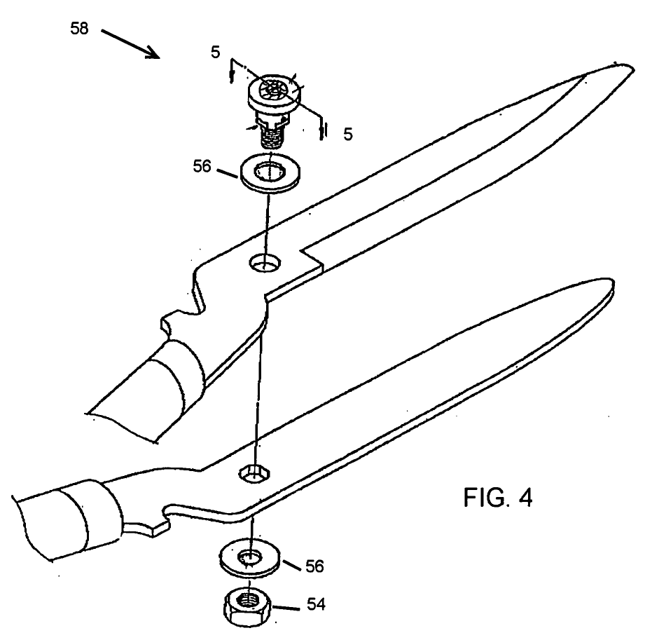

As noted hereinabove, two or more lubrication channels 42 may be employed in either of the illustrated embodiments. FIG. 6 is a top sectional view taken along line 6-6 of FIG. 3, showing a two channel configuration with the channels arranged on opposite sides of the bolt. Additional optional channels 42′ are shown in phantom. FIG. 7 is a top sectional view showing a non-symmetrical channel arrangement.

While the illustrated embodiment shows the lubrication bolt used in connection with a shearing tool, other uses include scissors, clamping type tools, such as pliers, for example.

While plural embodiments of the present invention has been shown and described, it will be apparent to those skilled in the art that many changes and modifications may be made without departing from the invention in its broader aspects. The appended claims are therefore intended to cover all such changes and modifications as fall within the true spirit and scope of the invention.

What is claimed is:

1. A lubrication fastener for joining at least two members for allowing pivoting of at least one member relative to the other, comprising:
a lubricant cell adapted to contain a lubricant;
a lubricant refilling well portion defined in the lubrication fastener for temporarily containing the lubricant prior to the lubricant being stored in the lubricant cell.

2. The lubrication fastener according to claim 1, wherein said lubricant refilling well comprises a beveled region defined in a portion of the fastener.

3. The lubrication fastener according to claim 1, wherein said lubricant cell includes an opening in communication with said well portion for communicating lubricant from said well to said cell.

4. The lubrication fastener according to claim 3, wherein said lubricant cell includes a covering member for substantially sealing the opening.

5. The lubrication fastener according to claim 3, wherein said lubricant cell includes a covering member and a biasing element for maintaining said covering member in a substantially sealing arrangement with the opening in absence of opposing force.

6. The lubrication fastener according to claim 5, wherein said covering member comprises a substantially spherical member.

7. The lubrication fastener according to claim 3, wherein said lubricant cell includes a covering member for substantially sealing the opening, said covering member adapted for variable insertion depth into said cell.

8. The lubrication fastener according to claim 7, wherein said covering member is in threaded relation with said lubricant cell, whereby relative rotation of said covering and said cell results in insertion or extraction of said covering into said cell.

9. The lubrication fastener according to claim 7, wherein insertion of said covering member into said lubricant cell operates to expel lubricant from said cell via at least one lubrication channel.

10. A lubrication fastener for joining at least two members for allowing pivoting of at least one member relative to the other, comprising:
a lubricant cell adapted to contain a lubricant;
at least two lubricant dispensing channels for conveying the lubricant from the lubricant cell to ate least one of the two members.

11. The lubrication fastener according to claim 10, wherein said at least two lubricant dispensing channels are regularly spaced relative to one another.

12. The lubrication fastener according to claim 10, wherein said at least two lubricant dispensing channels are irregularly spaced relative to one another.

13. The lubrication fastener according to claim 10, wherein said at least two lubricant dispensing channels are irregularly spaced relative to one another.

14. The lubrication fastener according to claim 10, further comprising:
a lubricant refilling well portion defined in the lubrication fastener for temporarily containing the lubricant prior to the lubricant being stored in the lubricant cell.

15. The lubrication fastener according to claim 14, wherein said lubricant refilling well comprises a beveled region defined in a portion of the fastener.

16. The lubrication fastener according to claim 14, wherein said lubricant cell includes an opening in communication with said well portion for communicating lubricant from said well to said cell.

17. The lubrication fastener according to claim 16, wherein said lubricant cell includes a covering member for substantially sealing the opening.

18. The lubrication fastener according to claim 16, wherein said lubricant cell includes a covering member and a biasing element for maintaining said covering member in a substantially sealing arrangement with the opening in absence of opposing force.

19. The lubrication fastener according to claim 18, wherein said covering member comprises a substantially spherical member.

20. The lubrication fastener according to claim 16, wherein said lubricant cell includes a covering member for substantially sealing the opening, said covering member adapted for variable insertion depth into said cell.

21. The lubrication fastener according to claim 20, wherein said covering member is in threaded relation with said lubricant cell, whereby relative rotation of said covering and said cell results in insertion or extraction of said covering into said cell.

22. The lubrication fastener according to claim 20, wherein insertion of said covering member into said lubricant cell operates to expel lubricant from said cell via at least one lubrication channel.

23. A tool employing the lubrication fastener of claim 1.

24. The tool according to claim 23, wherein said tool comprises a shearing tool.

25. A tool employing the lubrication fastener of claim 10.

26. The tool according to claim 25, wherein said tool comprises a shearing tool.
